(19) United States
(12) Patent Application Publication
(10) Pub. No.: US 2022/0343014 A1
(43) Pub. Date: Oct. 27, 2022

(54) API FOR SERVICE PROVIDER FULFILLMENT OF DATA PRIVACY REQUESTS

(71) Applicant: SoundHound, Inc., Santa Clara, CA (US)

(72) Inventors: Kevin QIU, Aurora (CA); Evelyn JIANG, Cupertino, CA (US); Matthias EICHSTAEDT, San Jose, CA (US); Warren S. HEIT, Palo Alto, CA (US)

(73) Assignee: SoundHound, Inc., Santa Clara, CA (US)

(21) Appl. No.: 17/237,705

(22) Filed: Apr. 22, 2021

(51) Int. Cl. G06F 21/62

(52) U.S. Cl. CPC G06F 21/6245

(57) ABSTRACT

A system and method are disclosed for fulfilling GDPR and other privacy requests in a client device system as well as a downstream service provider with which the client device system partners. In examples, the downstream service provider may be a voice assistant service provider providing voice recognition and language understanding capabilities to an upstream client device system.

### FIELD

The present technology relates to an application programming interface (API) for downstream fulfillment of GDPR and other data privacy requests by a service provider such as a voice assistant service provider.

### BACKGROUND

Automatic speech recognition (ASR) systems that recognize human speech, together with natural language understanding (NLU) capabilities that extract the meaning of the speech, are commonly used today as an easy and natural way to interface with speech-enabled devices. Providers of such voice assistants partner with a wide variety of companies that make voice-enabled client devices to improve the operation of the voice-enabled client devices.

As one example, voice assistant service providers partner with automobile companies to improve the human machine interface (HMI) for voice recognition and language understanding of an in-car virtual assistant. In such systems, user data and information are stored on servers of the automobile company, but user data and information are also stored downstream by the voice assistant service provider.

The General Data Protection Regulation (“GDPR”) is a regulation for data protection and privacy in the European Union (EU). California Consumer Privacy Act (CCPA) is a similar regulation for data protection in the United States. As part of the broad protections provided by the GDPR and CCPA, users are able to control their private data, and can require that companies that store their information either delete it or transfer it elsewhere. Portions of the United States are also beginning to put similar regulations into effect.

Systems currently exist that allow a user to interact with a client device, such as an in-car digital assistant, to fulfill a user privacy request, such as for the automobile company to delete the user data and information from their servers. However, at present, there is no system which also proliferates that privacy request to downstream service providers that partner with client device company.

### DESCRIPTION OF THE DRAWINGS

FIG. 1 is an illustration of a partner client device receiving a GDPR or other privacy request according to embodiments of the present technology.

FIG. 2 is a schematic block diagram of a system including a user interacting with a partner client device and a downstream service provider according to embodiments of the present technology.

FIG. 3 is a schematic block diagram of a client device system and a downstream service provider according to embodiments of the present technology.

FIG. 4 is a flowchart of the operation of a partner client device and partner servers for handling privacy requests according to embodiments of the present technology.

FIG. 5 is a flowchart of the operation of a downstream service provider for handling privacy requests to delete data received by an upstream client device according to embodiments of the present technology.

FIG. 6 is a flowchart of the operation of a downstream service provider for handling privacy requests to port data received by an upstream client device according to embodiments of the present technology.

FIG. 7 is a schematic block diagram of a computing environment according to embodiments of the present technology.

### DETAILED DESCRIPTION

The present technology will now be described with reference to the figures, which in embodiments, relate to a system for fulfilling GDPR, CCPA and other privacy requests in a client device system as well as a downstream service provider with which the client device system partners. Such privacy requests may for example be a user request to delete his or her personal data and information from client device system and the downstream service provider. Such privacy requests may also, for example, be a user request to port, or copy, downstream service provider data from one client device system to another, from one service provider to another, or from a service provider to a user's personal storage. In embodiments, the downstream service provider may be a voice assistant service provider providing voice recognition and language understanding capabilities to an upstream client device system. However, it is understood that the downstream service provider may be any of a wide variety of other types of service providers, providing services to a client device system, in further embodiments.

It is understood that the present invention may be embodied in many different forms and should not be construed as being limited to the embodiments set forth herein. Rather, these embodiments are provided so that this disclosure will be thorough and complete and will fully convey the invention to those skilled in the art. Indeed, the invention is intended to cover alternatives, modifications and equivalents of these embodiments, which are included within the scope and spirit of the invention as defined by the appended claims. Furthermore, in the following detailed description of the present invention, numerous specific details are set forth in order to provide a thorough understanding of the present invention. However, it will be clear to those of ordinary skill in the art that the present invention may be practiced without such specific details.

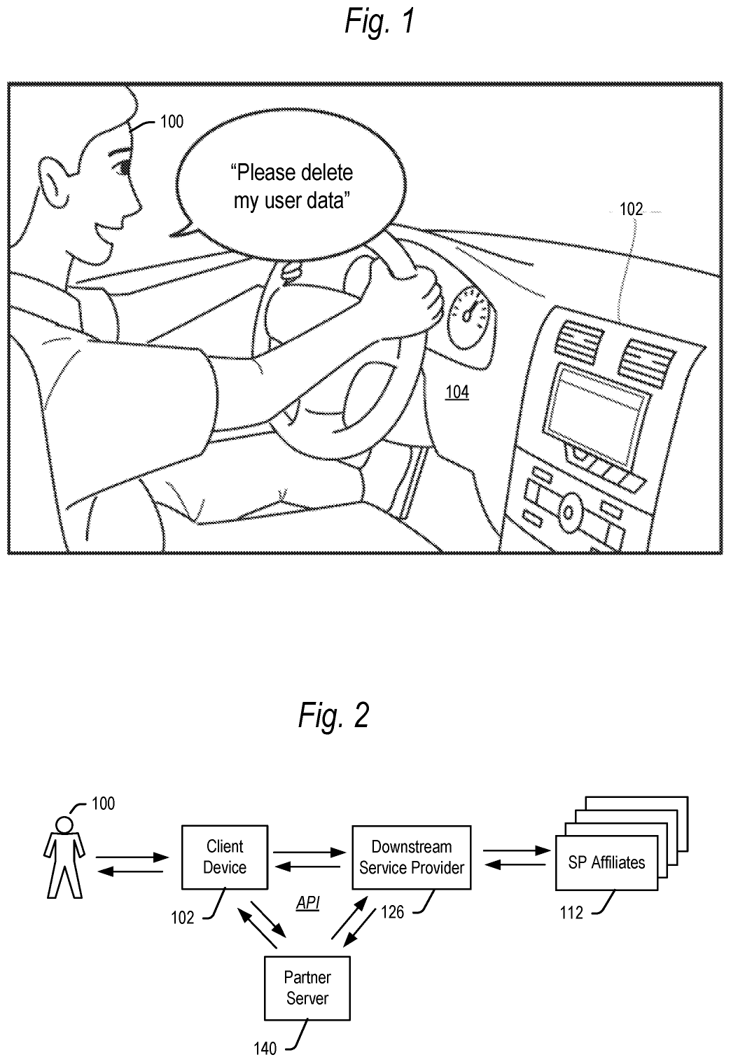

Referring now to FIG. 1, there is shown an illustration of a user 100 interacting with a client device 102 in the form of an in-car virtual assistant within an automobile 104. The user is making a GDPR, CCPA or other privacy request (hereinafter simply “privacy request”) to the client device 102 to delete his personal data from a service provider. In accordance with aspects of the present technology, such privacy requests are also implemented on a downstream service provider 126 (FIG. 2). As noted, in embodiments, the client device 102 may be an in-car digital assistant. However, it is understood that the present technology may be implemented using any of a wide variety of client devices, including for example an in-home digital assistant such as for example Alexa from Amazon, headquartered in Seattle Washington. Other client devices are contemplated.

While embodiments described herein relate to deleting and porting data, the present technology may be used to handle a variety of other privacy requests, including for example to modify data and to set a privacy policy with respect to their data. In such embodiments, such privacy requests made at a client device may be fulfilled at a partner server and a downstream service provider as described hereinafter.

Referring now to the block diagram of FIG. 2, once a user 100 issues a privacy request to client device 102, an API according to the present technology is used to implement the privacy request on one or more downstream service providers, such as for example a voice assistant used by the client device 102 to improve its voice recognition and natural language understanding with user 100. The downstream service provider 126 may work with one or more affiliates 112 to implement its service to client device 102, as described below.

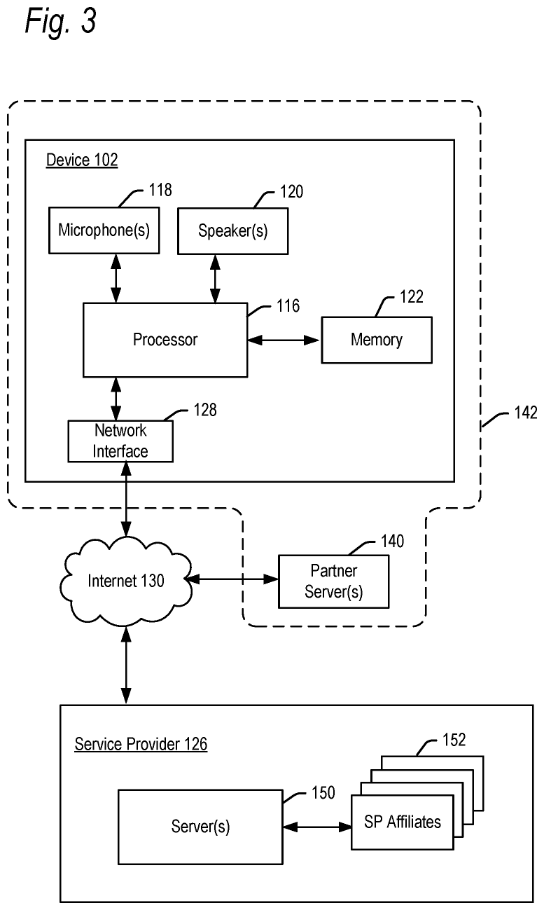

Referring now to the block diagram of FIG. 3, client device 102 may include a processor 116 configured to control the operations within device 102. The processor 116 may include a standardized processor, a specialized processor, a microprocessor, or the like that may execute instructions for controlling device 102. The processor 116 may be used to implement a human/machine interface (“HMI”) where device 102 can receive audio input from the user 100 via microphone(s) 118, and after processing of the audio input, the device 102 provides feedback to the user via speaker(s) 120. The audio may be processed by speech recognition and natural language processing algorithms resident in memory 122 and/or on a remote voice assistant service provider 126. The memory 122 may include RAM, ROM, cache, Flash memory, a hard disk, and/or any other suitable storage component. The device 102 may further include communications circuitry such as a network interface 128 for connecting to various cloud resources via the Internet 130. For example, audio input and/or other data and information may be transferred to and from the device 102 via the network interface 128 connecting to the Internet 130.

The client device 102 may also send and receive data and information to a server 140 associated with the device 102. For example, where the client device 102 is an in-car virtual assistant, the server 140 may be owned or controlled by the car maker or company that provided the car 104 and device 102. The client device 102 and server 140 are together referred to herein as a client device system 142. As noted in the Background section, the company providing or controlling the client device system 142 may partner with the service provider 126 to provide services to the client device 102, such as for example voice recognition and natural language understanding capabilities. Thus, the server 140 is also referred to herein as a partner server 140.

Service provider 126 may include one or more servers 150. A more detailed explanation of a sample server 150 is described below with reference to FIG. 9, but in general, server 150 may include a processor and memory which together implement algorithms supporting the service provider 126 and client device 102. For example, where service provider 126 is a voice assistant service, the processor may execute a speech recognition algorithm, a natural language understanding algorithm and/or other algorithms stored in the memory. In operation, audio input from user 100 is transmitted to the service provider 126, which then uses its algorithms to parse the input, and recognize and understand natural language queries and instructions in that audio input.

As part of its operation, the service provider 126 may store user information received from user 100, for example via client device 102. For example, the service provider 126 may store data received and/or generated relating to speech patterns and properties of the user 100 which the service provider uses to recognize and understand speech of the user 100. The service provider 126 may further receive and store data from user 100 included within audio input received from the user 100 via the client device 102. The service provider may further receive and store data from client device 102, such as user contacts and other information.

The service provider 126 may operate using one or more service provider affiliates, or SP affiliates, 152. These SP affiliates 152 may include their own servers configured to assist in the speech recognition and natural language processing of audio input received at service provider 126. Alternatively, the SP affiliates 152 may aid in providing information in response to queries processed by the service provider 126. As such, the SP affiliates may also store data and information on user 100. While the SP affiliates 152 are shown as being part of service provider 126 in FIG. 3, the SP affiliates 152 may include servers that are remote from service provider 126, and accessed by the service provider 126 via the Internet 130. While FIG. 3 shows multiple SP affiliates 152, there may be one or more in embodiments of the present technology. It is also conceivable that all functionality be performed by the service provider and that there be no affiliates in further embodiments.

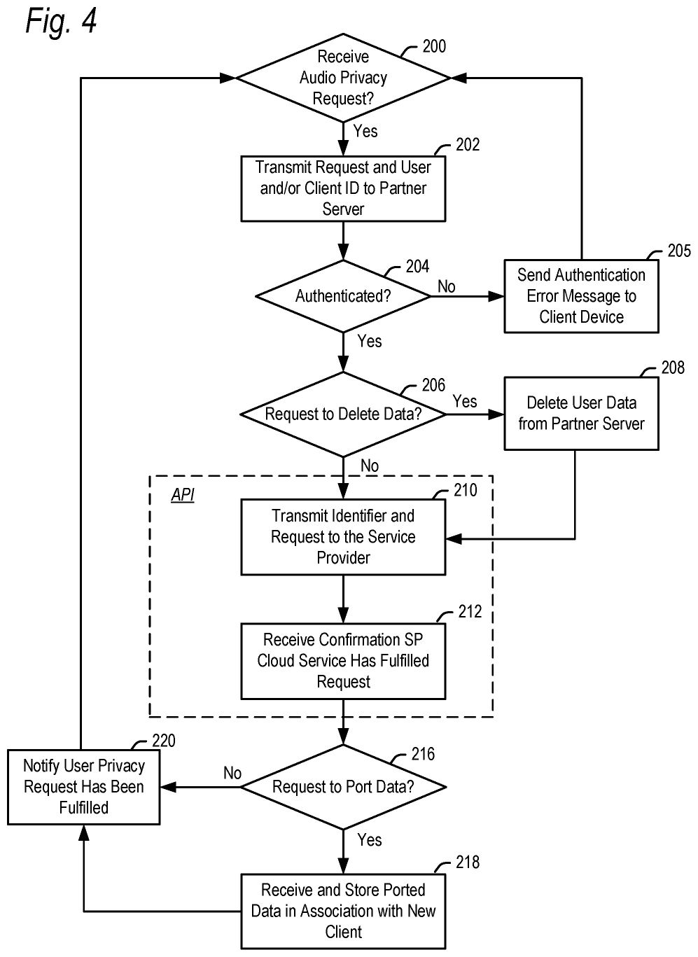

As noted in the Background section, the GDPR and various other privacy laws in the United States, Europe and elsewhere allow users to control their personal data, including for example to have it deleted or ported from servers such as those of partner servers 140 and service provider servers 150. The present technology includes an API which allows the user 102 to provide privacy requests via client device 102 which are implemented not only on the partner servers 140, but on the downstream servers 150 of the service provider 126. The operation of the present technology including the API will now be described with reference to the flowchart of FIGS. 4-6.

FIG. 4 in general describes the steps performed by client device 102 upon receipt of a privacy request. The client device checks for receipt of a privacy request in step 200. Such requests may for example be to delete privacy data and/or to port privacy data. The requests may for example be recognized with the assistance of the voice assistant service provider 126. In step 202, the request may be sent from client device 102 to the partner server 140, together with an identifier of the client device and, if available an identifier of the user 100 making the privacy request.

It is a feature of the present technology to prevent unauthorized deletion, porting, etc. of a user's data, for example where an unauthorized user is using client device 102. In step 204, the partner server 140 attempts to authenticate the received identifier(s) against its stored records for the client device and/or user. Various authentication protocols may be used. In one embodiment, the present technology may employ the OAuth or OAuth 2.0 authentication protocol, where users create an access token on an OAuth authentication server. When a privacy request is made, the request may include access token information. The access token information may be sent by the service provider 126 and/or partner server 140 to the OAuth authentication server for verification.

Other authentication protocols may be used in further embodiments. One such further example is authentication using voice (or other) biometrics. Such systems for example extract and compute a feature vector from biometrics obtained when a privacy request is made, and compare the feature vector to a stored feature vector for the authorized user. Another authentication option is to obtain user profile data (cell phone, email, etc.), and use two-factor authentication upon receipt of a privacy request.

If the authentication step fails, an authentication error message is sent to the client device (step 205) for notifying the user 100 of the failure, and the flow returns to step 200 to look for a new privacy request. In the event the partner server 140 is able to authenticate the client device and/or user, the partner server 140 checks in step 206 whether the privacy request was to delete the user data. If so, all privacy data or all data of any kind for the user may be deleted from memory of the partner server 140 in step 208. It may happen that user data is stored locally on client device 102. Such data may also be deleted from the client device in step 208.

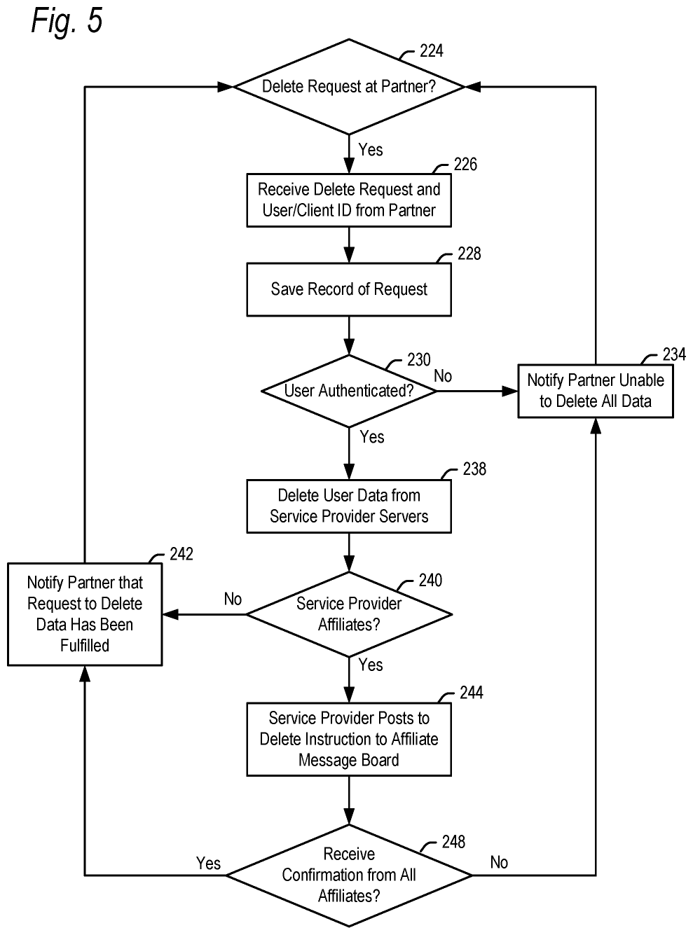

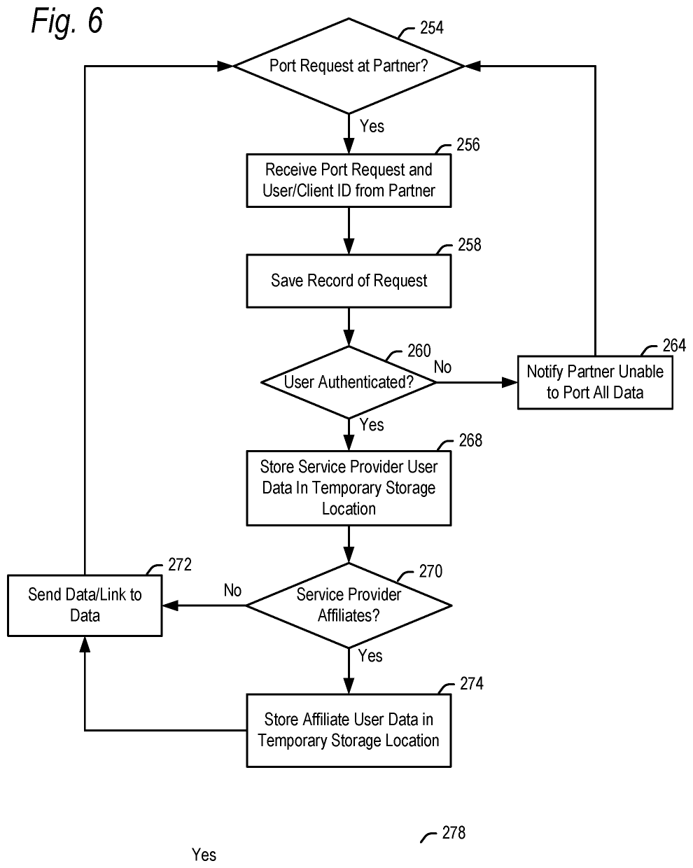

In accordance with aspects of the present technology, the partner server may execute an API which further causes the privacy request to be implemented on the downstream service provider 126. In particular, in step 210, the API causes an identifier for the user and/or client device to be sent to the service provider, together with the privacy request. The operations at the service provider 126 upon receipt of a privacy request per the API will be explained below in FIGS. 5 and 6. Once the privacy request has been fulfilled at the service provider 126, the API causes a confirmation to be sent to the partner server in step 212.

The partner server checks in step 216 whether the privacy request was to port (copy) data from the service provider. If so, the data is received from the service provider 126 and stored at the partner server 140 in step 218 for future download to the to a new client device 102. A message is then generated in step 220 for the client device to inform the user that the privacy request has been fulfilled. If the privacy request is not to port data in step 216, step 218 is skipped, and step 220 generating the fulfillment message is performed.

FIGS. 5 and 6 illustrate the operation of the present technology performed by the API at the service provider 126 for different privacy requests. The flowchart of FIG. 5 illustrates the steps for a delete request, and the flowchart of FIG. 6 illustrates the steps for a port request. The API of the present technology is triggered by receipt of a privacy request at the partner server 140. Referring initially to FIG. 5, in step 224, the API checks whether a delete privacy request was received at the partner server 140. If so, the request is sent to the service provider 126 in step 226, together with the user/client ID. The service provider saves a record of the request and ID in step 228. In step 230, the service provider and/or partner server performs a verification step to authenticate the user based on records stored at the service provider. As noted above, it is a feature of the present technology to ensure authentication to prevent deletion, porting, etc., of privacy data by an authorized user. The service provider and/or partner server may implement any of the various authentication protocols described above (or other) to ensure privacy requests for data are from an authorized user of that data. If the authentication fails, the service provider sends notification to the partner server 140 in step 234 that the user data was not deleted.

If the user is authenticated by the service provider in step 230, the service provider deletes all personal data, or all data of a specific kind, for the user 100 from the service provider server(s) 150 in step 238.

As noted above, one or more affiliates 152 may be used to assist the functionality of the service provider 126, which affiliates may also have personal user data. In step 240, the service provider 126 checks whether there are affiliates 152 assisting the service provider 126. If not, the service provider has finished fulfilling the deletion request, and a message is sent to the partner server 140 in step 242 that all downstream service provider user data has been deleted. A message may then be sent to client 102 that the request to delete data has been fulfilled.

If, on the other hand, there are affiliates in step 240, a message is posted to affiliate message boards in step 244 to delete all user data for the identified user. In step 248, the service provider checks whether it has received confirmation from all affiliates that have data for the user that all user privacy data, or all data of any kind, for the user has been deleted. If the deletion confirmation is received from all affiliates that have data for the user in step 248, a message is sent to the partner server 140 in step 242 that all downstream service provider user data has been deleted and a message is sent to the client device 102. If one or more affiliates respond that they were unable to delete the user's personal data, the service provider sends notification to the partner server 140 in step 234 that the user data was not deleted.

Some privacy regulations allow a user to obtain a copy of their data stored for example on a partner server 140 and/or service provider 126, and have that data sent, or ported, to a new client device. The steps for porting data shown in FIG. 6 are similar to those for deleting data shown in FIG. 5. In step 254, the API checks whether a port privacy request was received at the partner server 140. If so, the request is sent to the service provider 126 in step 256, together with the user/client ID. The service provider saves a record of the request and ID in step 258. In step 260, the service provider attempts to authenticate the user as described above. If the authentication fails, the service provider sends notification to the partner server 140 in step 264 that the user data was not ported.

If the user is authenticated by the service provider in step 260, the service provider copies the personal user data, or all data of a specific kind for the user, in step 268 into a temporary storage location. In step 270, the service provider 126 checks whether there are affiliates 152 assisting the service provider 126 which may have personal user data. If not, the service provider can finish fulfilling the port request in step 272 as explained below.

If, on the other hand, there are affiliates in step 270, a message is posted to affiliate message boards in step 274 for the affiliates to send the data to the service provider for storage in the temporary storage location (or the affiliates store the data directly in the temporary storage location).

In step 272, the service provider may send the user data (or a link to the user data) to the partner server 140 for the server 140 to save and forward to a new client device 102 specified by the user. It is possible that the service provider port the data (or a link to the data) directly to the client device 102 specified by the user in further embodiments. Once the user passes authentication protocols, the user may then download his/her data. Both the temporary storage of the data and the link to the data may have an expiration such that the data is only accessible if accessed within a defined time limit.

As noted, embodiments described above relate to deleting and porting data, but the present technology may be used to handle a variety of other privacy requests, including to modify data and to set a privacy policy with respect to their data. As an example of setting policy, if a user prefers that their data not be stored on the service provider servers, after receipt of the request and verification of the user, the service provider will update the privacy configuration for that user so that his/her user data will not be stored in service provider servers or service provider affiliates when handling subsequent service requests from this user.

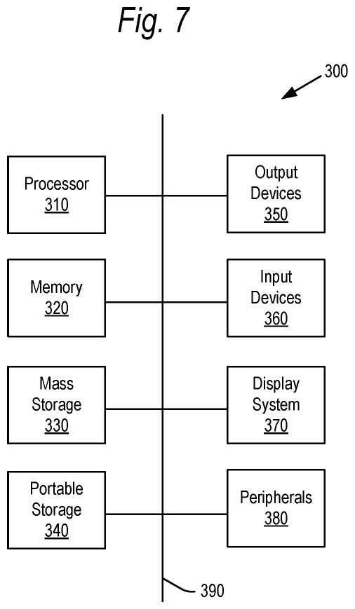

FIG. 7 illustrates an exemplary computing system 300 that may be device 102 or a server on the partner system 142 or service provider 126 used to implement embodiments of the present technology. The computing system 300 of FIG. 7 includes one or more processors 310 and main memory 320. Main memory 320 stores, in part, instructions and data for execution by processor unit 310. Main memory 320 can store the executable code when the computing system 300 is in operation. The computing system 300 of FIG. 7 may further include a mass storage device 330, portable storage medium drive(s) 340, output devices 350, user input devices 360, a display system 370, and other peripheral devices 380.

The components shown in FIG. 7 are depicted as being connected via a single bus 390. The components may be connected through one or more data transport means. Processor unit 310 and main memory 320 may be connected via a local microprocessor bus, and the mass storage device 330, peripheral device(s) 380, portable storage medium drive(s) 340, and display system 370 may be connected via one or more input/output (I/O) buses.

Mass storage device 330, which may be implemented with a magnetic disk drive an optical disk drive, or a Flash chip is a non-volatile storage device for storing data and instructions for use by processor unit 310. Mass storage device 330 can store the system software for implementing embodiments of the present invention for purposes of loading that software into main memory 320.

Portable storage medium drive(s) 340 can operate in conjunction with a portable non-volatile storage medium, such as a floppy disk, compact disk or Digital video disc, to input and output data and code to and from the computing system 300 of FIG. 7. The system software for implementing embodiments of the present invention may be stored on such a portable medium and input to the computing system 300 via the portable storage medium drive(s) 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 7 includes output devices 350. Suitable output devices include speakers, printers, network interfaces, and monitors. Where computing system 300 is part of a mechanical client device, the output device 350 may further include servo controls for motors within the mechanical device. Input device(s) 360 and output device(s) 350 may further be components for implementing a human/machine interface.

Display system 370 may include a liquid crystal display (LCD) or other suitable display device. Display system 370 receives textual and graphical information, and processes the information for output to the display device.

Peripheral device(s) 380 may include any type of computer support device to add additional functionality to the computing system. Peripheral device(s) 380 may include a modem or a router.

The components contained in the computing system 300 of FIG. 7 are those typically found in computing systems that may be suitable for use with embodiments of the present invention and are intended to represent a broad category of such computer components. Thus, the computing system 300 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In summary, the present technology relates to a method of fulfilling privacy requests from a client device at a downstream service provider, comprising: receiving a privacy request at the service provider, receipt of the privacy request at the service provider triggered by receipt of the privacy request sent from the client device to a server associated with the client device; fulfilling the privacy request at the service provider in response to receipt of the privacy request at the service provider; and transmitting confirmation of fulfillment of the privacy request at the service provider from the service provider to the server associated with the client device.

In another example, the present technology relates to a system for fulfilling privacy requests from a client device at a downstream service provider, comprising: a memory storage for storing data, the data including personal information of a user; and a processor configured to execute software code to: monitor a server associated with the client device for privacy requests received at the server from the client device, receive the privacy request at the service provider upon detecting receipt of the privacy request at the server associated with the client device, and access the memory storage to fulfill the privacy request at the service provider in response to receipt of the privacy request at the service provider.

In a further example, the present technology relates to one or more processor readable storage devices having processor readable code embodied on the processor readable storage devices, said processor readable code for programming one or more processors of a downstream server at a service provider to perform a method comprising the steps of: monitor an upstream server associated with a client device for privacy requests received at the server from the client device; receive the privacy request at the downstream server upon detecting receipt of the privacy request at the upstream server associated with the client device; fulfilling the privacy request at the service provider in response to receipt of the privacy request at the downstream server; and transmitting confirmation of fulfillment of the privacy request at the service provider from the service provider to the upstream server associated with the client device.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents. While the present invention has been described in connection with a series of embodiments, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the invention as described herein.

We claim:

1. A method of fulfilling privacy requests from a client device at a downstream service provider, comprising:
a) receiving a privacy request at the service provider, receipt of the privacy request at the service provider triggered by receipt of the privacy request sent from the client device to a server associated with the client device;
b) fulfilling the privacy request at the service provider in response to receipt of the privacy request at the service provider; and
c) transmitting confirmation of fulfillment of the privacy request at the service provider from the service provider to the server associated with the client device.

2. The method of claim 1, wherein the privacy request received in said step a) is a request to delete user data.

3. The method of claim 2, wherein the privacy request to delete user data is a privacy request to delete all personal data of the user.

4. The method of claim 2, wherein the privacy request to delete user data is a privacy request to delete all data of the user.

5. The method of claim 1, wherein the privacy request received in said step a) is a request to port user data to a second client device.

6. The method of claim 5, wherein the privacy request to port user data is a privacy request to port all personal data of the user.

7. The method of claim 2, wherein the privacy request to port user data is a privacy request to port all data of the user.

8. The method of claim 1, wherein said step b) of fulfilling the privacy request comprises the step of posting the privacy request to one or more affiliates of the service provider for the affiliates to fulfill the privacy request and send confirmation to the service provider.

9. The method of claim 1, further comprising the step of authenticating a user with the service provider before said step b) of fulfilling the privacy request.

10. A method of fulfilling privacy requests from a client device at a downstream service provider, comprising:
a) receiving a privacy request at the service provider, receipt of the privacy request at the service provider triggered by receipt of the privacy request sent from the client device to a server associated with the client device;
b) verifying that at least one of the client device and a user of the client device authorized to perform the privacy request;
c) fulfilling the privacy request at the service provider if the privacy request is verified in step b); and
d) transmitting confirmation of fulfillment of the privacy request at the service provider from the service provider to the server associated with the client device if the privacy request is verified in step b) and the privacy request is fulfilled in said step d).

11. The method of claim 10, wherein the privacy request received in said step a) is one of a request to delete user data and a request to port user data.

12. The method of claim 10, wherein said step b) of verification is performed by the service provider.

13. The method of claim 10, wherein said step b) of verification is performed by a partner of the service provider, the partner associated with the client device.

14. A system for fulfilling privacy requests from a client device at a downstream service provider, comprising:
a memory storage for storing data, the data including personal information of a user; and
a processor configured to execute software code to:
monitor a server associated with the client device for privacy requests received at the server from the client device,
receive the privacy request at the service provider upon detecting receipt of the privacy request at the server associated with the client device, and
access the memory storage to fulfill the privacy request at the service provider in response to receipt of the privacy request at the service provider.

15. The system of claim 14, wherein the processor is further configured to transmit confirmation of fulfillment of the privacy request at the service provider from the service provider to the server associated with the client device.

16. The system of claim 14, wherein the received privacy request is a request to delete the personal data of the user stored on the memory storage.

17. The system of claim 14, wherein the received privacy request is a request to port the personal data of the user stored on the memory storage to second client device.

18. The system of claim 14, wherein the processor is further configured to post the privacy request to one or more affiliates of the service provider for the affiliates to fulfill the privacy request.

19. The system of claim 18, wherein the processor is further configured receive confirmation from the one or more affiliates and forward the confirmation to the server associated with the client device.

20. The system of claim 14, further comprising the step of authenticating a user with the service provider before said step b) of fulfilling the privacy request.

21. The system of claim 20, further comprising the step of sending a failure message to the server for transmission to the client device in the event the processor is unable to authenticate the user.

22. One or more processor readable storage devices having processor readable code embodied on the processor readable storage devices, said processor readable code for programming one or more processors of a downstream server at a service provider to perform a method comprising the steps of:
a) monitor an upstream server associated with a client device for privacy requests received at the server from the client device;
b) receive the privacy request at the downstream server upon detecting receipt of the privacy request at the upstream server associated with the client device;
c) fulfilling the privacy request at the service provider in response to receipt of the privacy request at the downstream server; and
d) transmitting confirmation of fulfillment of the privacy request at the service provider from the service provider to the upstream server associated with the client device.

23. The one or more processor readable storage devices of claim 22, wherein privacy request fulfilled in said step c) is one of a request to delete personal user data or port personal user data.

24. The one or more processor readable storage devices of claim 22, wherein fulfilling the privacy request in said step c) further comprises the step of posting the privacy request to one or more affiliates of the service provider for the affiliates to fulfill the privacy request.
